(19) United States
(12) Patent Application Publication
(10) Pub. No.: US 2018/0100921 A1
(43) Pub. Date: Apr. 12, 2018

(54) ULTRASONIC SENSOR DEVICE AND SENSING METHOD OF ULTRASONIC SENSOR DEVICE

(71) Applicant: Hyundai Autron Co., Ltd., Seongnam-si (KR)

(72) Inventor: Sung Hoon Bang, Yongin-si (KR)

(73) Assignee: Hyundai Autron Co., Ltd., Seongnam-si (KR)

(21) Appl. No.: 15/724,143

(22) Filed: Oct. 3, 2017

(30) Foreign Application Priority Data
Oct. 11, 2016 (KR) 10-2016-0131370

(51) Int. Cl. G01S 15/08; G01S 15/93

(52) U.S. Cl. CPC G01S 15/08; G01S 2015/932; G01S 2015/938; G01S 15/931

(57) ABSTRACT

Provided is an ultrasonic sensor device and a sensing method. The device includes a first ultrasonic sensor that transmits an ultrasonic wave to an object in a transmission mode and receives an echo of the ultrasonic wave reflected from the object in a reception mode; at least one second ultrasonic sensor that is disposed near the first ultrasonic sensor and receives an echo of the ultrasonic wave reflected from the object; and a control unit that calculates a shortest distance signal with respect to the object by using a first distance signal outputted based on the echo received by the first ultrasonic sensor and a second distance signal outputted from the second ultrasonic sensor with the first ultrasonic sensor in the reception mode.

### CROSS-REFERENCE TO RELATED APPLICATIONS

This application claims priority to and the benefit of Korean Patent Application No. 10-2016-0131370 filed in the Korean Intellectual Property Office on Oct. 11, 2016, the entire contents of which are incorporated herein by reference.

### BACKGROUND

### Field

The present invention relates to an ultrasonic sensor, and more particularly, to an ultrasonic sensor device and a sensing method of an ultrasonic sensor device.

### Related Technology

Recently, automakers are developing vehicle safety related technologies and introducing more advanced safety technologies to the market. A typical example of this is the Advanced Driver Assistance System (ADAS), which is mainly used in connection with parking. Particularly, parking assistance system and automatic parking assistance system are widely used to inform the distance between the vehicle and object during parking. Key technologies in this system include a technology to measure the position of objects around the vehicle or the distance between the objects and the vehicle through an ultrasonic sensor.

The ultrasonic sensor is a sensor that emits an ultrasonic wave having a frequency of 20 KHz or more in an inaudible band and then senses an ultrasonic echo reflected from an external object to measure a distance to the external object. In automobiles, the ultrasonic echo sensed by the ultrasonic sensor is utilized to measure the distance to an object around the automobile, and to inform the driver in various ways such as a warning sound, display on the vehicle display, and the like.

However, the distance measuring apparatus utilizing the conventional ultrasonic sensor has limitations in the range of distance or accuracy. In particular, as the demand for various application fields exceeding the limits of the sensing range and accuracy of the conventional ultrasonic sensor is gradually increased, improvement of existing systems for measuring the distance using the ultrasonic sensor has become urgent. For example, it has become necessary to extend the sensing range of existing ultrasonic sensors and improve their accuracy for a variety of reasons, such as being able to sense a shorter distance for more efficient parking in a narrow parking space.

In such a conventional ultrasonic sensor device, one ultrasonic sensor generates ultrasonic waves, and the ultrasonic sensor that generates the ultrasonic waves receives the reflection of the ultrasonic waves from the object. However, when the object is not aligned in the vertical direction with respect to the ultrasonic sensor, the echo of the ultrasonic wave from the object is received at an inclined angle with respect to the ultrasonic sensor, such that the distance between the actual object and the vehicle can be determined after repeatedly generating and receiving ultrasonic waves. Furthermore, the distance with respect to the horizontal axis cannot be taken into account such that there is a limit to accurately measure the shortest distance between the vehicle and the object.

A related prior art is US Patent Publication No. US 2008/0218324 (published on Sep. 11, 2008).

### SUMMARY

The present invention has been made in an effort to solve or mitigate various problems including the above problems. An object of the present invention is to provide an ultrasonic sensor device in which one ultrasonic sensor may generate ultrasonic waves and a plurality of ultrasonic sensors may receive echo of the ultrasonic waves reflected from the object and that is capable of accurately calculating the actual distance between the vehicle and the object by considering the distance to the horizontal axis and the vertical axis by combining the received values of the plurality of ultrasonic sensors so as to determine the shortest distance between the vehicle and the object. However, these problems are only for illustrative purposes and the scope of the present invention is not limited thereto.

According to one aspect of the present invention, an ultrasonic sensor device is provided. The ultrasonic sensor device includes a first ultrasonic sensor that transmits an ultrasonic wave to an object in a transmission mode and receives an echo of the ultrasonic wave reflected from the object in a reception mode; at least one second ultrasonic sensor that is disposed near the first ultrasonic sensor and receives an echo of the ultrasonic wave reflected from the object; and a control unit that calculates a shortest distance signal with respect to the object by using a first distance signal outputted based on the echo received by the first ultrasonic sensor and a second distance signal outputted from the second ultrasonic sensor with the first ultrasonic sensor in the reception mode.

In the ultrasonic sensor device, the control unit may calculate the shorter signal among the first distance signal and the second distance signal as the shortest distance signal with the object.

In the ultrasonic sensor device, the control unit may combine the first distance signal and the second distance signal and calculate the value calculated using the trigonometric function as the shortest distance signal with the object.

In the ultrasonic sensor device, when the first ultrasonic sensor is in the transmission mode, the second ultrasonic sensor may be in a reception mode for receiving an echo of the ultrasonic wave reflected from the object.

In the ultrasonic sensor device, the first ultrasonic sensor and the second ultrasonic sensor may be disposed on the same plane and be horizontal with respect to the ground, such that two-dimensional coordinates of the object are generated.

The ultrasonic sensor device may further include at least one n-th ultrasonic sensor that is disposed near the first ultrasonic sensor or the second ultrasonic sensor and receives an echo of the ultrasonic wave reflected from the object.

In the ultrasonic sensor device, the n-th ultrasonic sensor may be arranged at a triangle with the first ultrasonic sensor and the second ultrasonic sensor, with a height from the ground that is different from the height of the first ultrasonic sensor and the second ultrasonic sensor that are disposed on the same plane so as to generate three-dimensional coordinates of the object.

According to one aspect of the present invention, a sensing method of an ultrasonic sensor device is provided. The method includes: a transmission step for transmitting an ultrasonic wave to an object using a first ultrasonic sensor; a first distance signal output step in which the first ultrasonic sensor receives an echo of the ultrasonic wave reflected from the object and outputs a first distance signal; a second distance signal output step in which at least one second ultrasonic sensor disposed near the first ultrasonic sensor receives an echo of the ultrasonic wave reflected from the object and outputs a second distance signal; and a shortest distance signal calculation step for calculating a shortest distance signal with the object using the first distance signal and the second distance signal.

In the sensing method, in the shortest distance signal calculation step, the shorter signal among the first distance signal and the second distance signal may be calculated to be the shortest distance signal with the object.

In the sensing method, in the shortest distance signal calculation step, the calculated value using the trigonometric function by combining the first distance signal and the second distance signal may be calculated to be the shortest distance signal with the object.

### Advantageous Effects

According to an embodiment of the present invention as described above, one ultrasonic sensor may generate ultrasonic waves and a plurality of ultrasonic sensors may receive echo of the ultrasonic waves reflected from the object. Here, the actual distance between the vehicle and the object is calculated accurately by considering the distance to the horizontal axis and the vertical axis by combining the received values of the plurality of ultrasonic sensors so as to determine the shortest distance between the vehicle and the object.

Furthermore, it is possible to calculate the coordinates of the object with respect to the horizontal axis and the vertical axis by a single ultrasonic wave generation, thereby shortening the system processing time and more accurately determining the position of the object, such that an ultrasonic sensor device and a sensing method thereof can be utilized for parking assistance system of vehicle. Of course, the scope of the present invention is not limited by these effects.

### DESCRIPTION OF THE DRAWINGS

FIG. 1 is a schematic view showing an ultrasonic sensor device according to an embodiment of the present invention.

FIG. 2 is a graph showing signals generated by the first ultrasonic sensor of the ultrasonic sensor device of FIG. 1.

FIG. 3 is a graph showing signals generated by the second ultrasonic sensor of the ultrasonic sensor device of FIG. 1.

FIG. 4 is a flowchart illustrating a sensing method of an ultrasonic sensor device according to an embodiment of the present invention.

### EXPLANATION OF REFERENCE NUMERALS

10: first ultrasonic sensor
20: second ultrasonic sensor
T: object
t1: time period for transmitting ultrasonic waves
t2: first distance signal
t3: second distance signal

### DETAILED DESCRIPTION

Hereinafter, embodiments of the present invention will be described in detail with reference to the accompanying drawings.

These embodiments are provided so that this disclosure will be thorough and complete, and will fully convey the scope of the invention to those skilled in the art. However, it should be understood that the present invention is not limited to the embodiments described below, but may be embodied in various other forms. Rather, these embodiments are provided so that this disclosure will be more thorough and complete, and will fully convey the scope of the invention to those skilled in the art. Also, the thickness or size of each layer in the drawings is exaggerated for convenience and clarity of explanation.

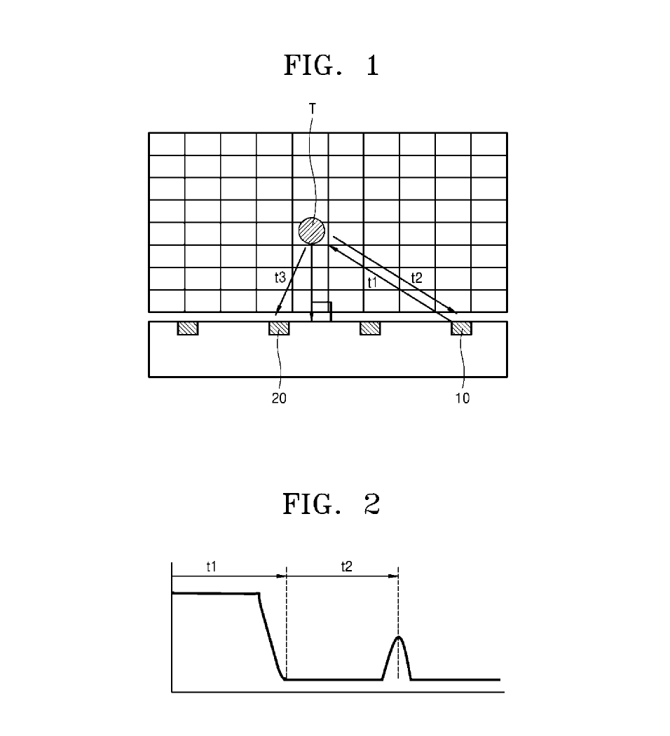

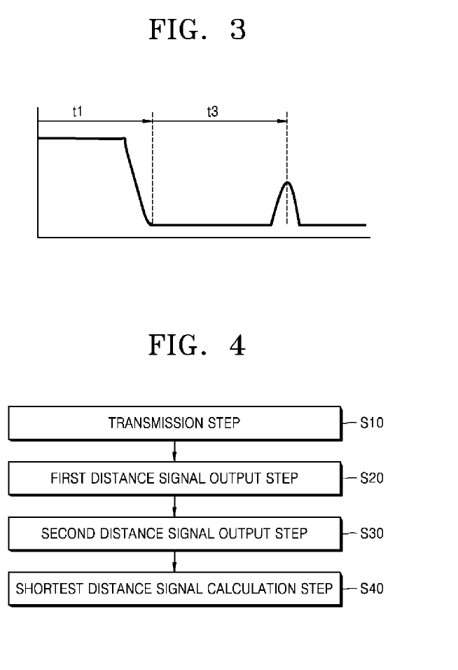

FIG. 1 is a schematic view showing an ultrasonic sensor device according to an embodiment of the present invention, FIG. 2 is a graph showing signals generated by the first ultrasonic sensor 10 of the ultrasonic sensor device of FIG. 1, and FIG. 3 is a graph showing signals generated by the second ultrasonic sensor 20 of the ultrasonic sensor device of FIG. 1.

Referring to FIG. 1, an ultrasonic sensor device according to an embodiment of the present invention may include a first ultrasonic sensor 10, a second ultrasonic sensor 20, and a control unit (not shown).

As shown in FIG. 1, the first ultrasonic sensor 10 can transmit an ultrasonic wave to an object T, in a transmission mode, and receive the echo of the ultrasonic wave reflected from the object T, in a reception mode.

More specifically, the first ultrasonic sensor 10 may include a transducer. Here, the first ultrasonic sensor 10 can transmit the ultrasonic wave by vibrating the transducer in accordance with the transmission pulse received from an ultrasonic driving device. Furthermore, when the echo of the ultrasonic wave reflected from the object T vibrates the transducer again, the transducer can convert the vibration into an electric signal and output the electric signal. Here, the transmission and reception of the ultrasonic wave are temporally separated into a transmission mode and a reception mode, and the transmission mode and the reception mode can be sequentially and repetitively performed.

At least one second ultrasonic sensor 20 is provided near the first ultrasonic sensor 10 and can receive the echo of the ultrasonic wave reflected from the object. Here, the second ultrasonic sensor 20 may have the same configuration and function as those of the first ultrasonic sensor 10 according to an embodiment of the present invention shown in FIG. 1 and therefore the detailed description thereof will be omitted.

Also, for example, when the first ultrasonic sensor 10 is in a transmission mode, the second ultrasonic sensor 20 may be in a reception mode for receiving the echo of the ultrasonic wave reflected from the object T. More specifically, the second ultrasonic sensor 20 may continue to be in the reception mode until the first ultrasonic sensor 10 enters the reception mode after the transmission mode.

Therefore, after the first ultrasonic sensor 10 generates an ultrasonic wave in the transmission mode, the first ultrasonic sensor 10 and the second ultrasonic sensor 20 may simultaneously maintain the reception mode for receiving the echo of the ultrasonic wave reflected from the object, such that one ultrasonic sensor generates ultrasonic waves and a plurality of ultrasonic sensors receive the echo of the ultrasonic wave reflected from the object.

Then, after the second ultrasonic sensor 20 generates an ultrasonic wave in the transmission mode, the first ultrasonic sensor 10 and the second ultrasonic sensor 20 may be alternately and repeatedly in the transmission mode in a manner in which the first ultrasonic sensor 10 and the second ultrasonic sensor 20 simultaneously maintain the reception mode for receiving the echo of the ultrasonic wave reflected from the object, such that the first ultrasonic sensor 10 and the second ultrasonic sensor 20 together receive the echo of the ultrasonic wave, which is generated in the transmission mode, reflected from the object.

Furthermore, the first ultrasonic sensor 10 and the second ultrasonic sensor 20 may be disposed on the same plane and horizontally with respect to the ground, such that two-dimensional coordinates of the X-axis and Y-axis of the object are generated. For example, the first ultrasonic sensor 10 and the second ultrasonic sensor 20 may be disposed horizontally with respect to the ground on the same plane at the same height as the ground at the rear end of the vehicle, such that the relative position of the object T located rearwardly of the rear end of the vehicle is generated to have two-dimensional coordinates of the X-axis and the Y-axis.

Furthermore, at least one n-th ultrasonic sensor may further be provided, which is disposed near the first ultrasonic sensor 10 or the second ultrasonic sensor 20 and receives the echo of an ultrasonic wave reflected from the object T. Here, the n-th ultrasonic sensor may be arranged at a triangle with the first ultrasonic sensor 10 and the second ultrasonic sensor 20, with a height from the ground that is different from the height of the first ultrasonic sensor 10 and the second ultrasonic sensor 20 that are disposed on the same plane so as to generate three-dimensional coordinates of the object T.

Accordingly, it is possible to generate the three-dimensional coordinates of the X-axis, the Y-axis, and the Z-axis of the object T located rearwardly of the rear end of the vehicle, thereby grasping not only the position of the object T located rearwardly of the vehicle but also the height of the object T.

Furthermore, referring to FIGS. 2 and 3, the control unit may calculate a shortest distance signal with respect to the object T by using a first distance signal t2 outputted based on the echo received by the first ultrasonic sensor 10 and a second distance signal t3 outputted from the second ultrasonic sensor 20 with the first ultrasonic sensor in the reception mode.

For example, as shown in FIG. 2, after the time period t1 when the first ultrasonic sensor 10 transmits ultrasonic waves, the time period until the echo of the ultrasonic waves reflected from the object T is received by the first ultrasonic sensor 10 can be outputted as the first distance signal t2. Furthermore, as shown in FIG. 3, after the time period t1 when the first ultrasonic sensor 10 transmits ultrasonic waves, the time period until the echo of the ultrasonic waves reflected from the object T is received by the second ultrasonic sensor 20 can be outputted as the second distance signal t3.

Here, the control unit may combine the first distance signal t2 and the second distance signal t3 and calculate the value calculated using the trigonometric function as the shortest distance signal with the object T. Here, the trigonometric function is a function in which a coordinate system having an X-axis and a Y-axis with zero as an origin on a plane, and a sine, a cosine, a tangent, a secant, a cosecant, and a cotangent according to the event connecting the point having the coordinate of the coordinate system and the origin. For example, if the distance between the first ultrasonic sensor 10 and the second ultrasonic sensor 20 is known and the angle of the object T is known by using the first distance signal t2 and the second distance signal t3, the distance between the object T and the vehicle can be accurately calculated.

For example, the first ultrasonic sensor 10 that generates ultrasonic waves may receive the flight time ToF corresponding to the sum of the time period t1 during which the ultrasonic waves are transmitted and the first distance signal t2, and the second ultrasonic sensor 20 may receive the flight time corresponding to the sum of the time period t1 during which the first ultrasonic sensor 10 transmits ultrasonic waves and the second distance signal t3. Therefore, the control unit can measure the lengths of the first distance signal t2 and the second distance signal t3 by generating ultrasonic waves only once. Through this, the actual distance between the object T and the vehicle can be calculated through the trigonometric function technique as described above. Furthermore, it is possible to calculate the position of the object T on the X-axis with respect to the vehicle through such a technique, and it is possible to generate two-dimensional coordinates.

Furthermore, in order to further simplify the calculation for calculating the shortest distance signal, the control unit may calculate the shorter signal among the first distance signal t2 and the second distance signal t3 as the shortest distance signal with the object T, without using the trigonometric function.

Therefore, as shown in FIGS. 1 to 3, in the ultrasonic sensor device according to the embodiment of the present invention, one ultrasonic sensor may generate ultrasonic waves and a plurality of ultrasonic sensors may receive echoes of the ultrasonic waves reflected from the object. Here, the actual distance between the vehicle and the object is calculated accurately by considering the distance to the horizontal axis and the vertical axis by combining the received values of the plurality of ultrasonic sensors so as to determine the shortest distance between the vehicle and the object.

Therefore, it is possible to calculate the coordinates of the object with respect to the horizontal axis and the vertical axis by a single ultrasonic wave generation, thereby shortening the system processing time and more accurately determining the position of the object, such that this technology can be utilized for parking assistance system of vehicle.

FIG. 4 is a flowchart illustrating a sensing method of an ultrasonic sensor device according to an embodiment of the present invention.

As shown in FIG. 4, the sensing method of the ultrasonic sensor device includes: a transmission step S10 for transmitting ultrasonic waves to the object T using the first ultrasonic sensor 10, a first distance signal output step S20 in which the first ultrasonic sensor 10 receives echo of the ultrasonic waves reflected from the object T and outputs a first distance signal t2, a second distance signal output step S30 in which at least one second ultrasonic sensor 20 disposed near the first ultrasonic sensor 10 receives echo of the ultrasonic waves reflected from the object T and outputs a second distance signal t3, and a shortest distance signal calculation step S40 for calculating a shortest distance signal with the object T using the first distance signal t2 and the second distance signal t3.

For example, in the shortest distance signal calculation step S40, the calculated value using the trigonometric function by combining the first distance signal t2 and the second distance signal t3 can be calculated to be the shortest distance signal with the object T. Furthermore, in the shortest distance signal calculation step S40, the shorter signal among the first distance signal t2 and the second distance signal t3 can be calculated to be the shortest distance signal with the object T.

Accordingly, as shown in FIG. 4, in the sensing method of the ultrasonic sensor device according to the embodiment of the present invention, one ultrasonic sensor may generate ultrasonic waves and a plurality of ultrasonic sensors may receive echo of the ultrasonic waves reflected from the object. Here, the actual distance between the vehicle and the object is calculated accurately by considering the distance to the horizontal axis and the vertical axis by combining the received values of the plurality of ultrasonic sensors so as to determine the shortest distance between the vehicle and the object.

Therefore, it is possible to calculate the coordinates of the object with respect to the horizontal axis and the vertical axis by a single ultrasonic wave generation, thereby shortening the system processing time and more accurately determining the position of the object, such that this technology can be utilized for parking assistance system of vehicle.

While the present invention has been described with reference to exemplary embodiments, it is to be understood that the invention is not limited to the disclosed exemplary embodiments, but, on the contrary, is intended to cover various modifications and equivalent arrangements included within the spirit and scope of the appended claims. Therefore, the true scope of the present invention should be determined by the technical idea of the appended claims.

1. An ultrasonic sensor device comprising:
a first ultrasonic sensor that transmits an ultrasonic wave to an object in a transmission mode and receives an echo of the ultrasonic wave reflected from the object in a reception mode;
at least one second ultrasonic sensor that is disposed near the first ultrasonic sensor and receives an echo of the ultrasonic wave reflected from the object; and
a control unit that calculates a shortest distance signal with respect to the object by using a first distance signal outputted based on the echo received by the first ultrasonic sensor and a second distance signal outputted from the second ultrasonic sensor with the first ultrasonic sensor in the reception mode.

2. The device of claim 1,
wherein the control unit calculates the shorter signal among the first distance signal and the second distance signal as the shortest distance signal with the object.

3. The device of claim 1,
wherein the control unit combines the first distance signal and the second distance signal and calculates the value calculated using the trigonometric function as the shortest distance signal with the object.

4. The device of claim 1,
wherein, when the first ultrasonic sensor is in the transmission mode, the second ultrasonic sensor is in a reception mode for receiving an echo of the ultrasonic wave reflected from the object.

5. The device of claim 1,
wherein the first ultrasonic sensor and the second ultrasonic sensor are disposed on the same plane and horizontally with respect to the ground, such that two-dimensional coordinates of the object are generated.

6. The device of claim 1, further comprising:
at least one n-th ultrasonic sensor that is disposed near the first ultrasonic sensor or the second ultrasonic sensor and receives an echo of the ultrasonic wave reflected from the object.

7. The device of claim 6,
wherein the n-th ultrasonic sensor is arranged at a triangle with the first ultrasonic sensor and the second ultrasonic sensor, with a height from the ground that is different from the height of the first ultrasonic sensor and the second ultrasonic sensor that are disposed on the same plane so as to generate three-dimensional coordinates of the object.

8. A sensing method of an ultrasonic sensor device, the method comprising:
a transmission step for transmitting an ultrasonic wave to an object using a first ultrasonic sensor;
a first distance signal output step in which the first ultrasonic sensor receives an echo of the ultrasonic wave reflected from the object and outputs a first distance signal;
a second distance signal output step in which at least one second ultrasonic sensor disposed near the first ultrasonic sensor receives an echo of the ultrasonic wave reflected from the object and outputs a second distance signal; and
a shortest distance signal calculation step for calculating a shortest distance signal with the object using the first distance signal and the second distance signal.

9. The method of claim 8,
wherein, in the shortest distance signal calculation step, the shorter signal among the first distance signal and the second distance signal is calculated to be the shortest distance signal with the object.

10. The method of claim 8,
wherein, in the shortest distance signal calculation step, the calculated value using the trigonometric function by combining the first distance signal and the second distance signal is calculated to be the shortest distance signal with the object.
